(19) United States
(12) Patent Application Publication
(10) Pub. No.: US 2012/0301113 A1
(43) Pub. Date: Nov. 29, 2012

(54) PICTURE EDITING APPARATUS AND PICTURE EDITING METHOD

(76) Inventor: Yukiko YAMAMOTO, Osaka (JP)

(21) Appl. No.: 13/405,003

(22) Filed: Feb. 24, 2012

(30) Foreign Application Priority Data
May 25, 2011 (JP) 2011-116557

(51) Int. Cl. G11B 27/02; H04N 5/93

(52) U.S. Cl. 386/280; 386/E05.028

(57) ABSTRACT

A picture editing apparatus is provided which is capable of adding a transition effect with less redundancy to a group of pictures to be sequentially displayed. The picture editing apparatus adds, to at least one of sequential pictures to be switched, a transition effect that is display processing to be performed in sequentially switching a plurality of pictures, and includes: an obtainment unit that obtains the pictures; a transition effect determination unit that determines the transition effect to be added in sequentially switching the pictures, based on a presentation effect associated with the at least one of the sequential pictures to be switched, the presentation effect being associated with each of the obtained pictures as display processing to be performed on the picture; and a display control unit that adds the presentation effect and the transition effect to the pictures and sequentially display the pictures on a display apparatus.

### CROSS REFERENCE TO RELATED APPLICATION

The present application is based on and claims priority of Japanese Patent Application No. 2011-116557 filed on May 25, 2011. The entire disclosure of the above-identified application, including the specification, drawings and claims is incorporated herein by reference in its entirety.

### BACKGROUND OF THE INVENTION

(1) Field of the Invention

The present invention relates to picture editing apparatuses and particularly to a picture editing apparatus or the like which is capable of editing a plurality of pictures which are displayed sequentially.

(2) Description of the Related Art

Electronic devices and programs capable of sequentially displaying obtained materials such as still picture data items or moving picture data items are known. Such electronic devices and programs do not only simply sequentially display pictures. For example, some electronic device or program adds a view effect to each one of picture data items. Furthermore, some electronic devices and programs add a view effect in view transition from one picture to another. Hereinafter, a view effect added to each one of sequentially displayed pictures is referred to as “a presentation effect”. Specifically, display processing to be performed on each of pictures in displaying the pictures sequentially on a display apparatus is referred to as the presentation effect. Furthermore, a view effect in view transition to another picture is referred to as “a transition effect”. Specifically, display processing to be performed on one picture and the following picture in view transition from the one picture to the following picture is referred to as the transition effect. The electronic devices and programs often use shooting information on pictures when adding the presentation effects and the transition effects to the pictures. For example, Patent Literature 1 (Japanese Unexamined Patent Application Publication No. 2005-32219) discloses an image display method in which a display position of each image is controlled using shooting information on images in arranging a large number of image data items on a screen.

### SUMMARY OF THE INVENTION

However, in the image display method disclosed in Patent Literature 1, the image display method is determined based on the shooting information, which means that the same display processing is performed on pictures with the same shooting information. There is therefore a possibility that the presentation effect becomes redundant in the case where obtained pictures include pictures with the same shooting information.

The present invention has been devised in view of the above problem and has an object to provide a picture editing apparatus capable of adding a transition effect with less redundancy to a group of pictures to be sequentially displayed.

In order to achieve the above object, a picture editing apparatus according to an aspect of the present invention is a picture editing apparatus which adds, to at least one of sequential pictures to be switched, a transition effect that is display processing to be performed in sequentially switching a plurality of pictures, the picture editing apparatus comprising: an obtainment unit configured to obtain the pictures; a transition effect determination unit configured to determine the transition effect to be added to the at least one of the sequential pictures to be switched, based on a presentation effect associated with the at least one of the sequential pictures to be switched, the presentation effect being associated with each of the obtained pictures as display processing to be performed in displaying the picture; and a display control unit configured to add the presentation effect and the transition effect to the pictures and sequentially display the pictures on a display apparatus.

With this structure, the picture editing apparatus is capable of determining the transition effect based on the presentation effect previously associated with the picture. This allows a reduction in redundancy caused by sequence of the same transition effect.

It is to be noted that the present invention can be implemented not only as such a picture editing apparatus, but also as a picture editing method including, as steps, characteristic means included in the picture editing apparatus and as a program which causes a computer to execute such characteristic steps. Here, it goes without saying that the above program may be distributed via a recording medium such as a compact disc read only memory (CD-ROM) and a communication network such as the Internet.

Furthermore, the present invention can be implemented as a semiconductor integrated circuit (LSI) which provides part or all of the functions of the above picture editing apparatus and as a picture editing system which includes the above picture editing apparatus.

According to the present invention, it is possible to provide a picture editing apparatus capable of adding the transition effect with less redundancy to a group of pictures to be sequentially displayed.

### BRIEF DESCRIPTION OF THE DRAWINGS

These and other objects, advantages and features of the invention will become apparent from the following description thereof taken in conjunction with the accompanying drawings that illustrate a specific embodiment of the present invention. In the Drawings:

FIG. 1 shows an entire structure of a picture editing system including a picture editing apparatus according to Embodiment of the present invention;

FIG. 2 is a block diagram showing an example of hardware configuration of a computer system implemented by the picture editing apparatus according to Embodiment of the present invention;

FIG. 3 shows an example of a file structure of a still picture or the like obtained in Embodiment of the present invention;

FIG. 4 shows an example of a table indicating an association between shooting information and a presentation effect according to Embodiment of the present invention;

FIG. 5 shows an example of a table indicating an association between the presentation effect and a transition effect according to Embodiment of the present invention;

FIG. 6 shows an image of a selection screen on a liquid crystal display according to Embodiment of the present invention;

FIG. 7 shows an image of a check screen on the liquid crystal display according to Embodiment of the present invention;

FIG. 8 illustrates a hierarchical structure in a template according to Embodiment of the present invention;

FIG. 9 shows examples of the presentation effect according to Embodiment of the present invention;

FIG. 10 shows examples of the transition effect according to Embodiment of the present invention;

FIG. 11 is a flowchart showing a flow of entire processing which the picture editing apparatus according to Embodiment performs;

FIG. 12 is a flowchart showing a process flow in which the picture editing apparatus according to Embodiment of the present invention creates content data;

FIG. 13 is a detailed flowchart showing a process flow in which in the picture editing apparatus according to Embodiment of the present invention creates the content data;

FIG. 14 is a flowchart showing a detailed flow of processing which a transition effect determination unit according to Embodiment of the present invention performs; and

FIG. 15 is a flowchart showing a detailed flow of other processing which the transition effect determination unit according to Embodiment of the present invention performs.

### DESCRIPTION OF THE PREFERRED EMBODIMENTS

In order to achieve the above object, a picture editing apparatus according to an aspect of the present invention is a picture editing apparatus which adds, to at least one of sequential pictures to be switched, a transition effect that is display processing to be performed in sequentially switching a plurality of pictures, the picture editing apparatus comprising: an obtainment unit configured to obtain the pictures; a transition effect determination unit configured to determine the transition effect to be added to the at least one of the sequential pictures to be switched, based on a presentation effect associated with the at least one of the sequential pictures to be switched, the presentation effect being associated with each of the obtained pictures as display processing to be performed in displaying the picture; and a display control unit configured to add the presentation effect and the transition effect to the pictures and sequentially display the pictures on a display apparatus.

With this structure, the picture editing apparatus is capable of determining the transition effect based on the presentation effect associated with the picture. This allows a reduction in redundancy caused by sequence of the same transition effect.

Furthermore, it may be possible that the transition effect determination unit is configured to determine the transition effect to be added in switching from one to the other of a first picture and a second picture, from among a plurality of candidate transition effects which are determined based on at least one of the presentation effect associated with the first picture and the presentation effect associated with the second picture, the first and the second pictures being included in the pictures, and the second picture being a picture which is displayed preceding or following the first picture.

With this, the candidate transition effects to be used in transition from one picture to another are determined based on the presentation effect associated with each of the two pictures which are displayed sequentially. By determining, from among these candidates, the transition effect to be used ultimately, the picture editing apparatus is capable of further reducing redundancy. Furthermore, it is possible to determine the transition effect which visually causes no feeling of strangeness with the presentation effect associated with each of the two pictures.

Furthermore, it may be possible that the first picture is a picture which is displayed preceding the second picture, and the transition effect determination unit is configured to determine, with reference to a transition table, the transition effect to be added, from among the candidate transition effects so that use frequency of each of the candidate transition effects is equal to or lower than a predetermined threshold, the transition table being a table in which at least one of a first presentation effect associated with the first picture and a second presentation effect associated with the second picture is associated with a plurality of candidate transition effects that can be added in switching from the first picture to the second picture.

Furthermore, it may be possible that each of the candidate transition effects has a priority, and the transition effect determination unit is configured to determine to preferentially add the candidate transition effect with a higher priority.

Furthermore, the transition effect determination unit may be configured to determine a transition direction of each of the first picture and the second picture in the transition effect so as to match at least one of a shift direction of the first picture in the first presentation effect and a shift direction of the second picture in the second presentation effect.

Furthermore, a presentation effect determination unit may be further provided which is configured to determine, from among a plurality of candidate presentation effects previously associated with shooting information added to each of the obtained pictures, the presentation effect to be associated with the picture, based on a priority of each of the candidate presentation effects.

Furthermore, a picture editing method according to another aspect of the present invention is a picture editing method of adding, to at least one of sequential pictures to be switched, a transition effect that is display processing to be performed in sequentially switching a plurality of pictures, the picture editing method comprising: obtaining the pictures; determining the transition effect to be added to the at least one of the sequential pictures to be switched, based on a presentation effect associated with the at least one of the sequential pictures to be switched, the presentation effect being associated with each of the obtained pictures as display processing to be performed in displaying the picture; and adding the presentation effect and the transition effect to the pictures and sequentially displaying the pictures on a display apparatus.

The following describes Embodiments of the present invention in detail with reference to the drawings. It is to be noted that each of Embodiments described below shows a specific preferred example of the present invention. Numeric values, shapes, constituents, positions and topologies of the constituents, steps, an order of the steps, and the like in the following Embodiments are an example. It should therefore not be construed that the present invention is limited to each of these Embodiments. The present invention is limited only by the scope of the claims. Thus, out of the constituents in the following Embodiments, the constituents not stated in the independent claims describing the broadest concept of the present invention are not always necessary to achieve the object of the present invention, but are described as constituents in a more preferable embodiment.

The picture editing apparatus according to Embodiment of the present invention is capable of adding the presentation effect and the transition effect with less redundancy to a group of pictures to be sequentially displayed. Accordingly, the presentation effect and the transition effect which are visually more effective can be added to the group of pictures. This embodiment describes a case of creating a movie as an example of the group of pictures to be sequentially displayed.

In creating a movie according to this embodiment, story data are created according to a template selected by a user. The template is information which includes display time periods of the pictures to be sequentially arranged and the presentation effect to be added to each of the pictures, for example. The story data are information which defines, on a time axis, the number of pictures to be sequentially displayed on a display apparatus, the display time period of each of the pictures, and the presentation effect to be added to each of the pictures, for example. On the time axis indicated in the created story data, identification information indicating each of the pictures, and a correction of the presentation effect and the transition effect are arranged to create content data. A picture editing apparatus 100 creates a movie from the content data.

With reference to the drawings, a structure and operation of a system are described in detail below.

### [1. Structure of System]

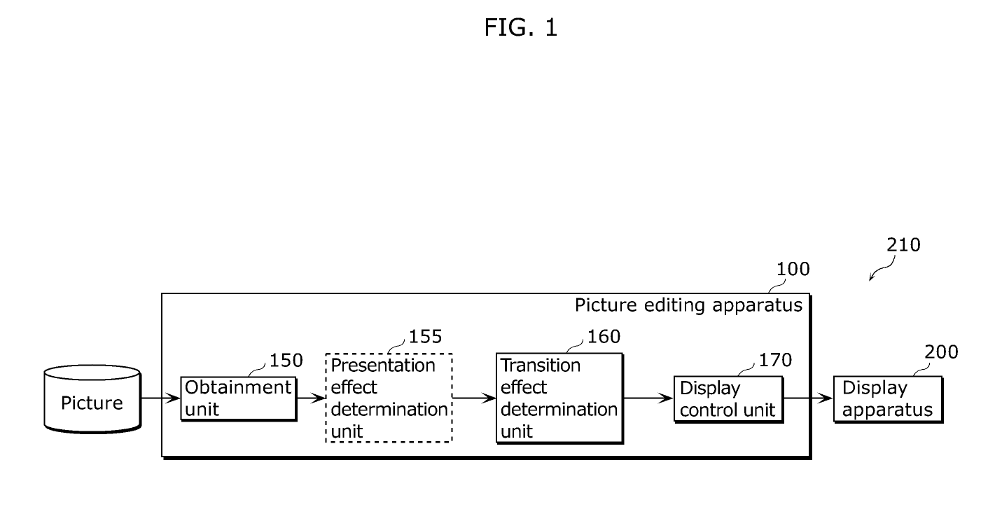

First, a structure of a system of the picture editing apparatus 100 according to this embodiment is described with reference to FIG. 1. FIG. 1 shows an entire structure of a picture editing system 210 including the picture editing apparatus 100.

As shown in FIG. 1, the picture editing system 210 includes the picture editing apparatus 100 and a display apparatus 200. The picture editing apparatus 100 creates content data from a plurality of obtained pictures. Furthermore, the picture editing apparatus 100 causes the display apparatus 200 to display a movie made from the created content data.

The picture editing apparatus 100 is a picture editing apparatus which adds, to at least one of sequential pictures to be switched, the transition effect that is display processing to be performed in sequentially switching the plurality of pictures. In more detail, the picture editing apparatus 100 includes an obtainment unit 150, a presentation effect determination unit 155, a transition effect determination unit 160, and a display control unit 170.

The obtainment unit 150 obtains, for example, picture information indicating the plurality of pictures from a recoding medium, such as a hard disk drive (HDD), a solid state drive (SSD), or an SD memory card. To simplify description, “to obtain picture information indicating a picture” may be hereinafter expressed as “to obtain a picture”.

The presentation effect determination unit 155 determines, for each picture, the presentation effect that is display processing to be performed in displaying the obtained picture on the display apparatus 200. Specifically, out of a plurality of candidate presentation effects previously associated with shooting information added to each of the plurality of obtained pictures, the presentation effect to be associated with the picture is determined based on the priorities set for respective presentation effects. More details will be described below.

The transition effect determination unit 160 determines the transition effect to be used by the picture editing apparatus 100. Specifically, the transition effect determination unit 160 determines the transition effect to be added to at least one of sequential pictures to be switched, from among a plurality of candidate transition effects determined based on the presentation effect which, as the display processing to be performed on each of the plurality of obtained pictures, has been previously associated with the picture.

More specifically, the transition effect determination unit 160 determines the transition effect to be added to at least one of sequential pictures to be switched, from among the plurality of candidate transition effects determined based on at least one of the presentation effect associated with a first picture out of the plurality of pictures, and the presentation effect associated with a second picture out of the plurality of pictures that is a picture preceding or following the first picture in display order.

The display control unit 170 adds the presentation effects and the transition effect to the plurality of pictures and causes the display apparatus 200 to sequentially display the resultant pictures.

The display apparatus 200 is a display apparatus capable of displaying still pictures and moving pictures. Specifically, the display apparatus 200 is a liquid crystal display, a plasma display, an organic electroluminescence (EL) display, or the like.

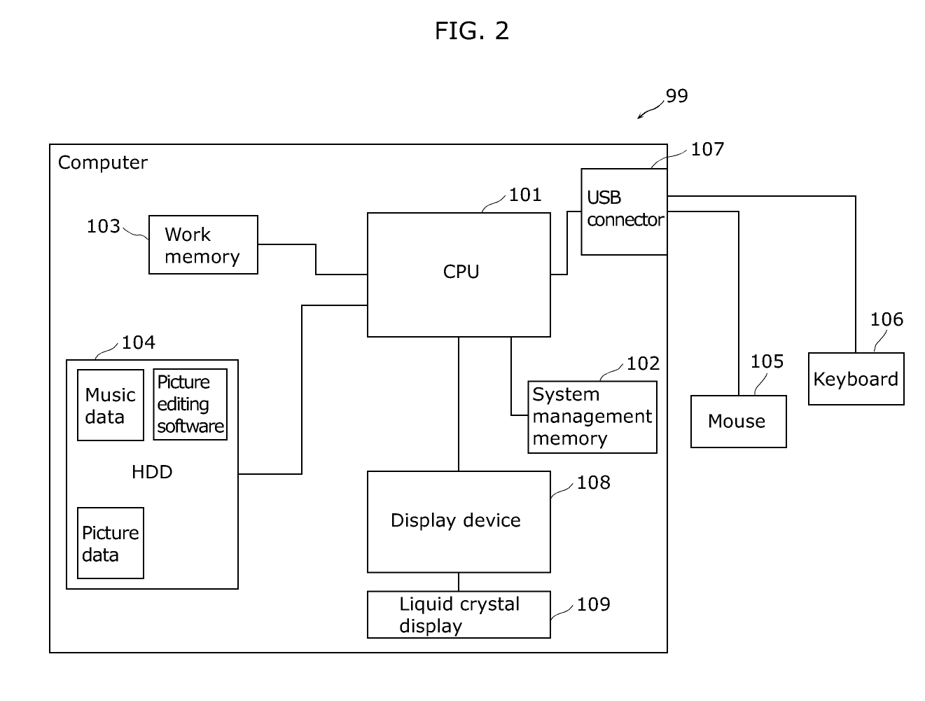

Next, with reference to FIG. 2, hardware configuration of a computer system which implements the picture editing apparatus 100 according to Embodiment is described.

FIG. 2 is a block diagram showing an example of the hardware configuration of the computer system which implements the picture editing apparatus 100.

As shown in FIG. 2, the picture editing apparatus 100 includes a computer 99, a mouse 105, and a keyboard 106.

The computer 99 includes a CPU 101, a system management memory 102, a work memory 103, an HDD 104, a USB connector 107, a display device 108, and a liquid crystal display 109.

The CPU 101 is a processing unit which executes processing to be performed by the picture editing apparatus 100. The CPU 101 is electrically connected to the system management memory 102, the work memory 103, the HDD 104, the display device 108, and the USB connector 107. Using the display device 108, the CPU 101 is capable of changing a screen on the liquid crystal display 109. Furthermore, the CPU 101 receives, through the USB connector 107, operation information from a user using the mouse 105 and the keyboard 106. Moreover, although not shown, the CPU 101 controls a whole system including power which is supplied to each unit of the picture editing apparatus 100.

The system management memory 102 is a memory in which an operating system (OS) and the like are held. Furthermore, in the system management memory 102, a system time and the like are stored. The system time is updated upon operation of a program in OS by the CPU 101.

The work memory 103 is a memory in which information necessary for the CPU 101 to execute various processing is temporarily stored. The CPU 101 creates story data and content data according to a template selected by a user, an input picture selected by a user, a presentation effect table, and a transition effect table. In the work memory 103, information of the template selected by the CPU 101, information on the story data and the content data which are being created, and the like are stored. The template information, the presentation effect table, and the transition effect table will be described below in detail.

The USB connector 107 is a connector for connecting the mouse 105 and the keyboard 106 with the picture editing apparatus 100.

The display device 108 is a device which provides images based on screen information resulting from calculation in the CPU 101. The display device 108 notifies the liquid crystal display 109 of the screen information. The screen information which is displayed on the liquid crystal display 109 is specifically an operation screen or the like including a graphical user interface (GUI) for operating the picture editing apparatus 100.

The liquid crystal display 109 is a display device which displays the images of screen information provided by the display device 108. Instead of the liquid crystal display 109, a given apparatus, such as a plasma display or an organic EL display, may be used.

The mouse 105 is a pointing device which a user uses in editing operation. By operating the mouse 105, a user can select a picture data item and a template on the operation screen displayed on the liquid crystal display 109.

The keyboard 106 is a keyboard device with which a user inputs characters in editing operation.

In the above-described computer 99, the CPU 101 reads, from the HDD 104, picture editing software for implementing the picture editing apparatus, and stores it in the work memory 103. Next, the CPU 101 activates the picture editing software to execute processing. For example, the CPU 101 executes the following processing according to a program of the picture editing software:
(1) obtaining, through the USB connector 107, the selection operation and the editing operation from a user using the mouse 105 and the keyboard 106;
(2) reading descriptions of the template selected by a user to create story data;
(3) arranging input pictures on the time axis indicated in the story data, adjusting, based on the presentation effect table, the presentation effect on the time axis indicated in the story data, and placing, based on the transition effect table, the transition effect on the time axis indicated in the story data, to create content data; and
(4) providing the picture information indicating the created content data to the display device 108 in order to display the content data on the liquid crystal display 109.

### [2. Structures of Still Picture and Moving Picture]

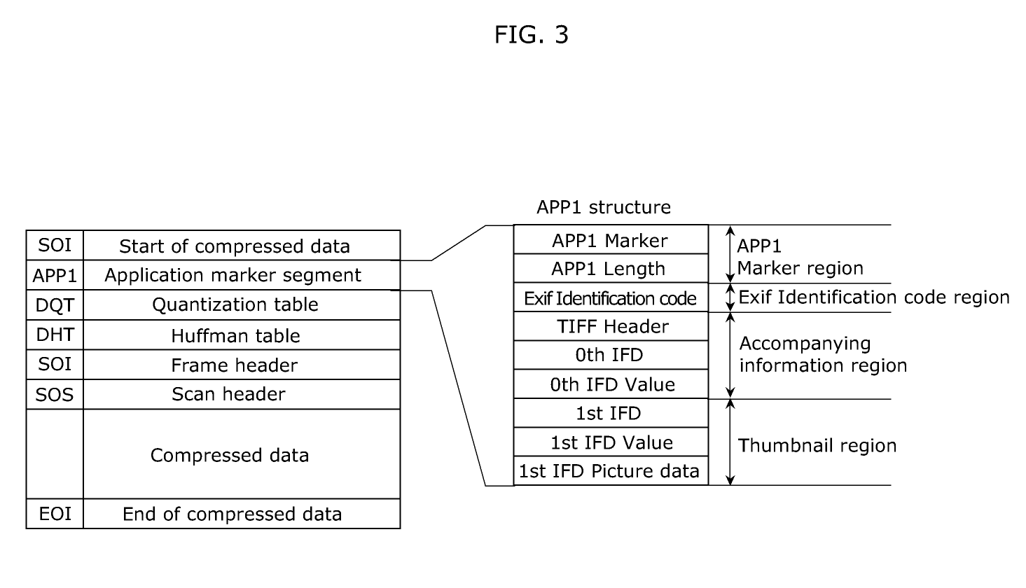

Subsequently, a file structure of a still picture or a moving picture obtained by the obtainment unit 150 in this embodiment is described with reference to FIG. 3. FIG. 3 shows an image of the file structure of a still picture stored in the HDD 104. As an example of the file structure, an exchangeable image file format (Exif) is given in the following description.

As shown in FIG. 3, the file structure includes a header region and a data recording region. In the header region, various data for managing this file are stored. Specifically, the header region includes a region “SOI” for storing a start of compressed data and a region “APP1” for storing an application marker segment. The data recording region includes “DQT” for recording a quantization table, “DHT” for storing a Huffman table, a region “SOF” for storing a frame header, a region “SOS” for storing a scan header, a region for storing entropy coded data (compressed data), and a marker code “EOI” indicating an end of the entropy coded data.

The region “APP1” in the header region further includes an APP1 marker region, a region for storing an Exif identification code, an accompanying information region, and a thumbnail region. The APP1 marker region further includes a region for storing data of APP1 marker and a region for storing data of APP1 length. The accompanying information region includes a region for storing a TIFF header, a region for storing a 0th IFD, and a region for storing a 0th IFD value. To put it differently, in the accompanying information, accompanying information (such as shooting information) related to a picture (a main picture) of the entropy coded data is stored. The thumbnail region includes a region for storing a 1st IFD, a region for storing a 1st IFD value, and a region for storing a thumbnail picture.

### [3. Structure of Association Between Shooting Information and Presentation Effect]

The presentation effect determination unit 155 according to this embodiment determines, based on the shooting information included in the accompanying information of one picture, the presentation effect associated with the picture.

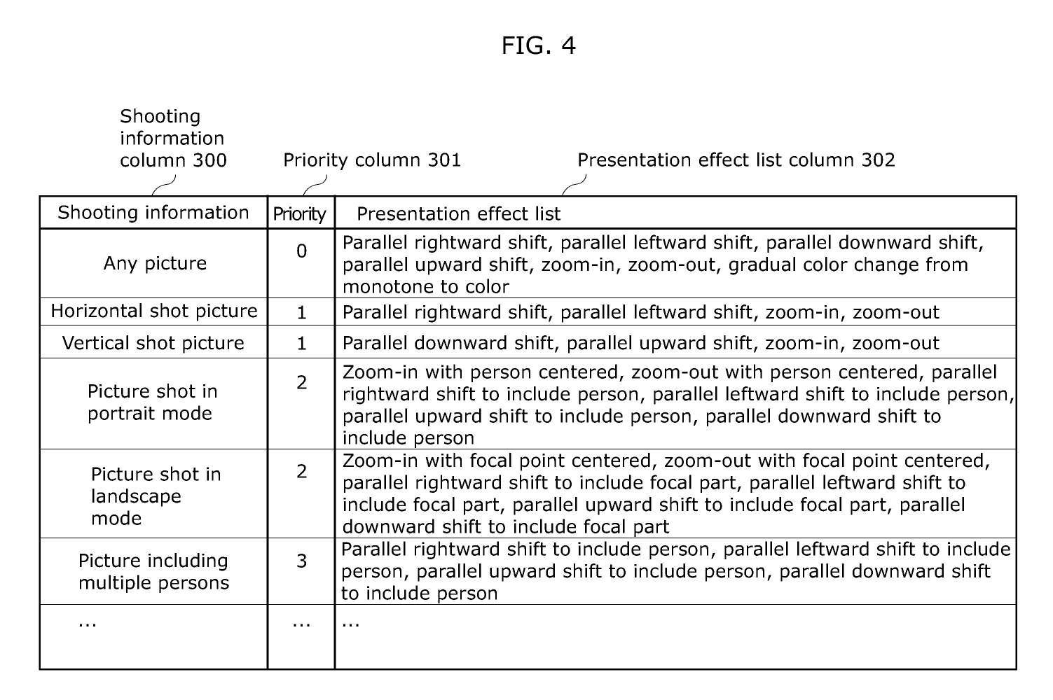

Thus, an example of the association between the shooting information and the presentation effect which the presentation effect determination unit 155 uses in this embodiment is described with reference to FIG. 4.

FIG. 4 shows an example of a table indicating the association between the shooting information and the presentation effect.

As shown in FIG. 4, the table indicating the association between the shooting information and the presentation effect includes a shooting information column 300, a priority column 301, and a presentation effect list column 302.

The shooting information column 300 shows a list of the shooting information, described with reference to FIG. 3, which is added to a picture when the picture is taken. The shooting information is information indicating, for example, an aspect ratio of a picture, focal point information, coordinates of a position of a human face, and the number of human faces. Furthermore, the shooting information includes also information indicating types of the shooting mode, such as a portrait mode and a landscape mode.

The priority column 301 shows priorities for selecting the shooting information. Specifically, in the case where the shooting information of the obtained picture corresponds to plural items of the shooting information column 300, the priority column 301 shows which shooting information is to be preferentially selected as the shooting information of the picture. For example, when the shooting information of an obtained picture indicates that the picture is a horizontal shot picture including an image of multiple persons, this input picture corresponds to three items of the shooting information column 300 shown in FIG. 4: “Horizontal shot picture”, “Picture shot in portrait mode”, and “Picture including multiple persons”. However, of these items of the shooting information, “Picture including multiple persons” has a priority “3”, which is highest. Accordingly, the picture editing apparatus 100 adopts “Picture including multiple persons” as the shooting information of the picture. Furthermore, when the shooting information of an obtained picture indicates “Vertical shot picture” and does not indicate whether any person is included or any landscape is included, the picture editing apparatus 100 adopts “Vertical shot picture” as the shooting information of the picture. The priorities may be expressed using numerical values as shown in FIG. 4 or may be expressed using means other than the numerical values. In FIG. 4, a larger value indicates a higher priority.

The presentation effect list column 302 cites candidate presentation effects which are suitable for each item of the shooting information. For example, a horizontal shot picture is longer in width than height. It is therefore conceivable that a parallel horizontal shift (a parallel rightward shift or a parallel leftward shift) is suitable as the presentation effect. Thus, in the table shown in FIG. 4, a parallel rightward shift and a parallel leftward shift are stated as the candidate presentation effects for the horizontal shot picture.

Here, in the case where there are consecutive pictures with the same shooting information in reproduction of a created movie, the same presentation effect will continue. As a result, the presentation effect will be redundant. In order to avoid such redundancy in the presentation effect, the presentation effect determination unit 155 according to this embodiment includes, as the candidates in the presentation effect list for the horizontal shot picture, not only the parallel rightward shift and the parallel leftward shift, but also zoom-in and zoom-out that are the presentation effects less dependent on picture attributes.

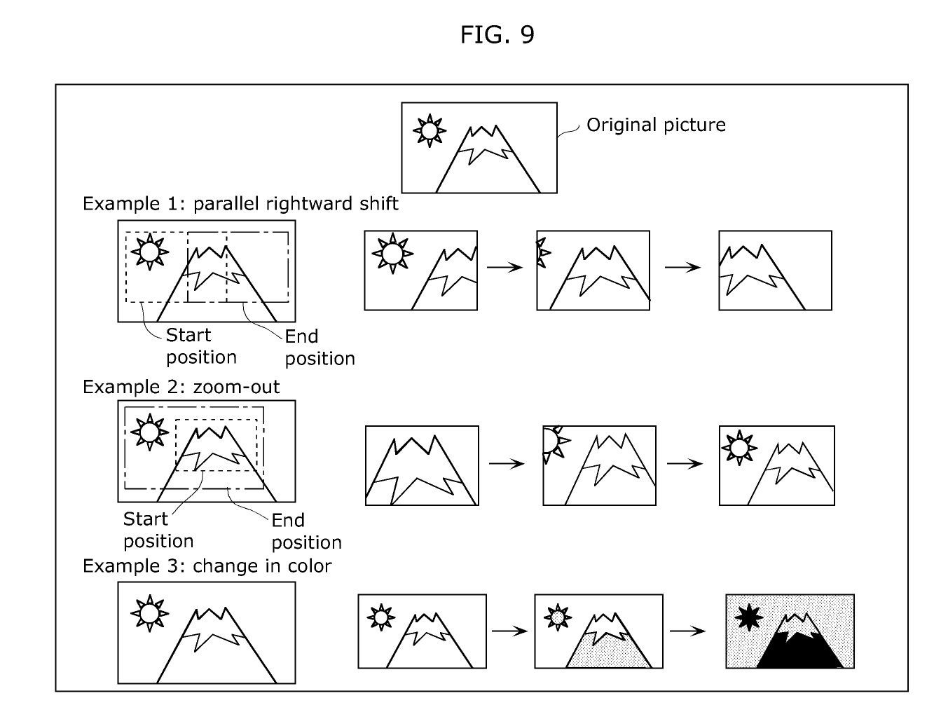

Here, with reference to FIG. 9, examples of the presentation effect are described.

FIG. 9 shows examples of the presentation effect in this embodiment. FIG. 9 illustrates, as the presentation effect, each of “parallel rightward shift (Example 1)”, “zoom-out (Example 2)”, and “change in color (Example 3)”.

Next, with reference back to FIG. 4, in this embodiment, the presentation effect list with the lowest priority “0” is set as the presentation effect list which can correspond to any picture. This allows the presentation effect determination unit 155 to include, in options, a candidate presentation effect with less redundancy. For example, if there is no presentation effect list with the priority “0”, the parallel rightward shift, the parallel leftward shift, zoom-in, and zoom-out will be repeatedly applied as the presentation effect in the case where “Horizontal shot picture” is successive. However, with the presentation effect list with the priority “0” which can correspond to any picture, it is possible to avoid rotation of only the candidate presentation effects included in the presentation effect list associated with “Horizontal shot picture”.

In other word, the presentation effect determination unit 155 selects the presentation effect list associated with the shooting information of a target picture, with reference to the table indicating, as shown in FIG. 4, the association between the shooting information of pictures and the presentation effect list that cites a plurality of candidate presentation effects. In the case where there are a plurality of the presentation effect lists associated with the shooting information, the presentation effect list with the highest priority is selected in principle. From among the plurality of candidate presentation effects included in the presentation effect list selected as above, the presentation effect determination unit 155 determines the presentation effect.

Here, when the presentation effect list includes two or more candidate presentation effects, the presentation effect which is different from the immediately previously selected presentation effect is determined. This is to avoid redundancy in the presentation effect.

It is to be noted that the presentation effect determination unit 155 may determine the presentation effect different from the immediately previously selected presentation effect, from the union of a set of the candidate presentation effects with the highest priority associated with the shooting information and a set of the candidate presentation effects with the lowest priority associated with the shooting information. Furthermore, in the case where there are a plurality of the presentation effect lists associated with the shooting information and the presentation effect list with the highest priority is the same as the immediately previously used presentation effect list, the presentation effect may be determined from the presentation effect list with a lower priority.

### [4. Structure of Association Between Presentation Effect and Transition Effect]

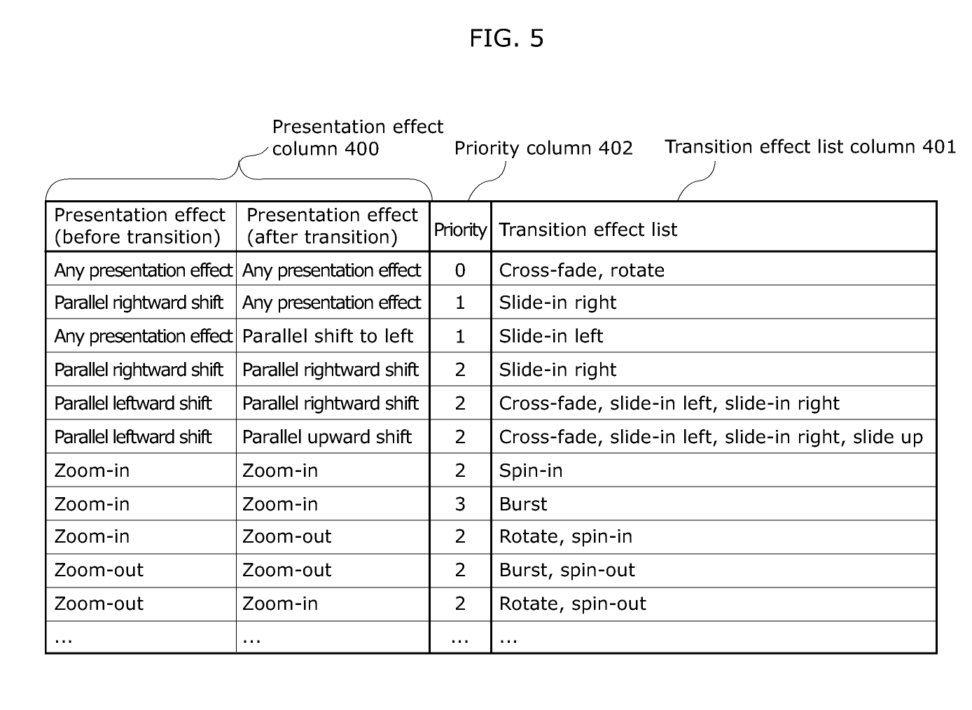

The transition effect determination unit 160 according to this embodiment determines the transition effect based on the presentation effect. Thus, an example of the association between the presentation effect and the transition effect which the picture editing apparatus 100 according to this embodiment uses is described with reference to FIG. 5.

FIG. 5 shows an example of a table (which may hereinafter be referred to a transition table) indicating the association between the presentation effect and the transition effect.

As shown in FIG. 5, the transition table includes a presentation effect column 400, a transition effect list column 401, and a priority column 402.

The presentation effect column 400 shows a list of the presentation effects. In FIG. 5, the transition effect is determined in association with each of the presentation effect associated with the preceding picture that is displayed before transition (the presentation effect before transition), and the presentation effect associated with the following picture that is displayed after transition (the presentation effect after transition). However, it may also be possible to determine the transition effect in association with only one of the presentation effects, that is, the presentation effect before transition or the presentation effect after transition. Furthermore, it may also be possible to determine the transition effect in association with the presentation effects associated with three respective pictures: a certain picture and pictures preceding and following the certain picture.

The transition effect list column 401 cites candidate transition effects which can be suitably used between two presentation effects, after a certain presentation effect, or before a certain presentation effect. For example, in the case where both of the presentation effect before transition and the presentation effect after transition are “Parallel rightward shift”, it is conceived that the picture should preferably be shifted rightward, which is the same as the presentation effects before and after transition. Thus, as shown in FIG. 5, the transition effect list column 401 shows “Slide-in right” for “Parallel rightward shift” in both of the presentation effects before and after transition. Furthermore, for “Parallel leftward shift” in the presentation effect before transition and “Parallel rightward shift” in the presentation effect after transition, it is conceived that the picture should preferably be shifted either left, which is the same as the presentation effect before transition, or right, which is the same as the presentation effect after transition. Thus, for “Parallel leftward shift” in the presentation effect before transition and “Parallel rightward shift” in the presentation effect after transition, the transition effect list column 401 shows “Slide-in left” and “Slide-in right” as corresponding transition effects. Furthermore, in order to avoid transition effect redundancy caused by sequence of the same transition effect, the transition effect list additionally includes, as a candidate, “Cross-fade” that is a standard transition effect.

This means that the transition effect determination unit 160 may determine a shift direction of each of the first picture and the second picture in the transition effect so as to match at least one of a shift direction of the first picture in the first presentation effect and a shift direction of the second picture in the second presentation effect.

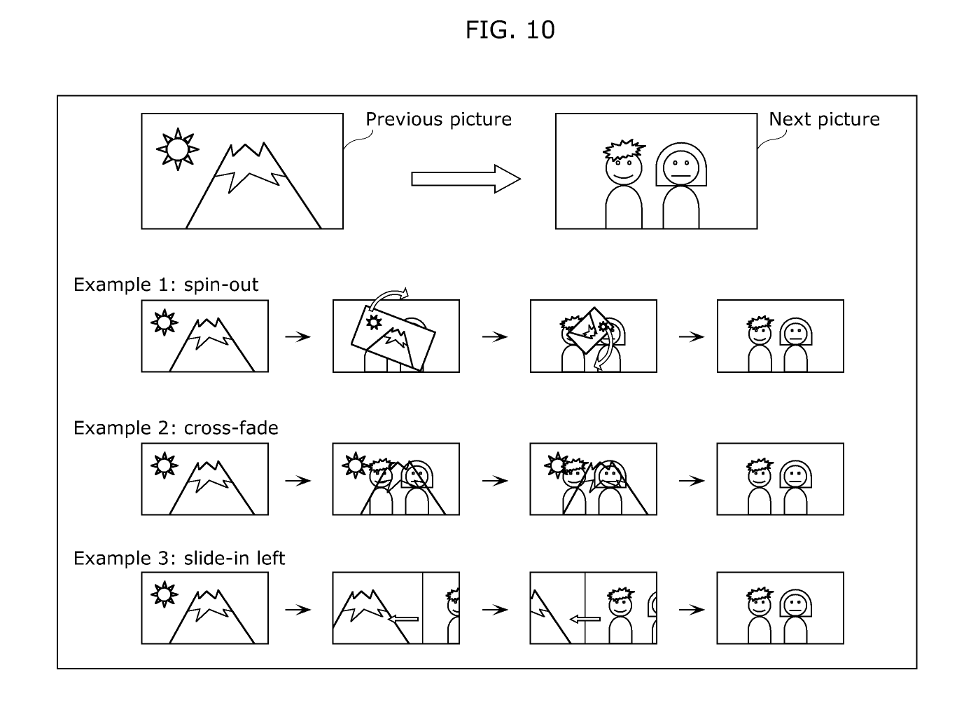

Here, with reference to FIG. 10, a specific example of the transition effect is described.

FIG. 10 shows examples of the transition effect. FIG. 10 illustrates the display processing to be performed on sequential pictures to be switched, in the case of using each of “Spin-out (Example 1)”, “Cross-fade (Example 2)” and “Slide-in left (Example 3)” as the presentation effect.

Next, with reference back to FIG. 5, the priority column 402 indicates priorities of the transition effect lists. The priorities may be expressed using numerical values as shown in FIG. 5 or may be expressed using means other than the numerical values. In FIG. 5, a larger value indicates a higher priority.

Specifically, the transition table shown in FIG. 5 includes, as a candidate of the transition effect that is the display processing associated with a certain presentation effect before transition and a certain presentation effect after transition, (1) a candidate transition effect in the same transition effect list and (2) a candidate transition effect in a transition effect list with a different priority.

The transition effect determination unit 160 refers to the presentation effect column 400 in the transition table in order to determine the transition effect. Next, the transition effect determination unit 160 selects the transition effect list with the highest priority from the transition effect list column 401 corresponding to the rows with a corresponding presentation effect before transition and a corresponding presentation effect after transition. Subsequently, from among the candidate transition effects included in the transition effect list, the transition effect determination unit 160 determines the transition effect to be used. When the transition effect list cites two or more effects, a transition effect different from an immediately previously used transition effect is selected to avoid redundancy in the transition effect.

When there are a plurality of corresponding transition effect lists, a transition effect list other than the transition effect with the highest priority may be selected to avoid redundancy. For example, when the presentation effect to be added to the first picture is “Zoom-in” and the presentation effect to be added to the second picture is “Zoom-in”, there are “Spin-in” with a priority 2 and “Burst” with a priority 3 as corresponding transition effects. Here, “Burst” with a higher priority is selected. Thus, the transition effect to be used in switching between the first picture and the second picture will be “Burst”. Subsequently, when the presentation effect to be added to the third picture that is displayed following the second picture is also “Zoom-in”, there are likewise “Spin-in” with a priority 2 and “Burst” with a priority 3 as corresponding transition effects. Here, the transition effect determination unit 160 may select “Spin-in” with the priority 2, which is a lower priority, in order to select a transition effect different from an immediately preceding transition effect. At this time, the transition effect to be used in switching between the second picture and the third picture will be “Spin-in”.

As described above, assuming that the first picture is a picture which is displayed preceding the second picture, the transition effect determination unit 160 refers to the transition table in which at least one of the first presentation effect associated with the first picture and the second presentation effect associated with the second picture is previously associated with a plurality of candidate transition effects that can be added in switching from the first picture to the second picture. Subsequently, the transition effect determination unit 160 may determine the transition effect to be added, from among the candidate transition effects, so that use frequency of each of the candidate transition effects is equal to or lower than a predetermined threshold.

Here, the use frequency of the transition effect may be calculated as the number of times or its ratio that the candidate is used as the transition effect within the defined number of times which are most recent, that is, for example, “the transition effect is used three times out of the last five times” or “the transition effect which is the same as the last one is used”.

At this time, each of the candidate transition effects has a priority, and the transition effect determination unit 160 may preferentially determine a candidate transition effect with a higher priority.

This allows the transition effect determination unit 160 to determine the transition effect which has less redundancy and causes no feeling of strangeness with the presentation effect used for each of the sequential pictures.

### [5. Structure of Selection Screen]

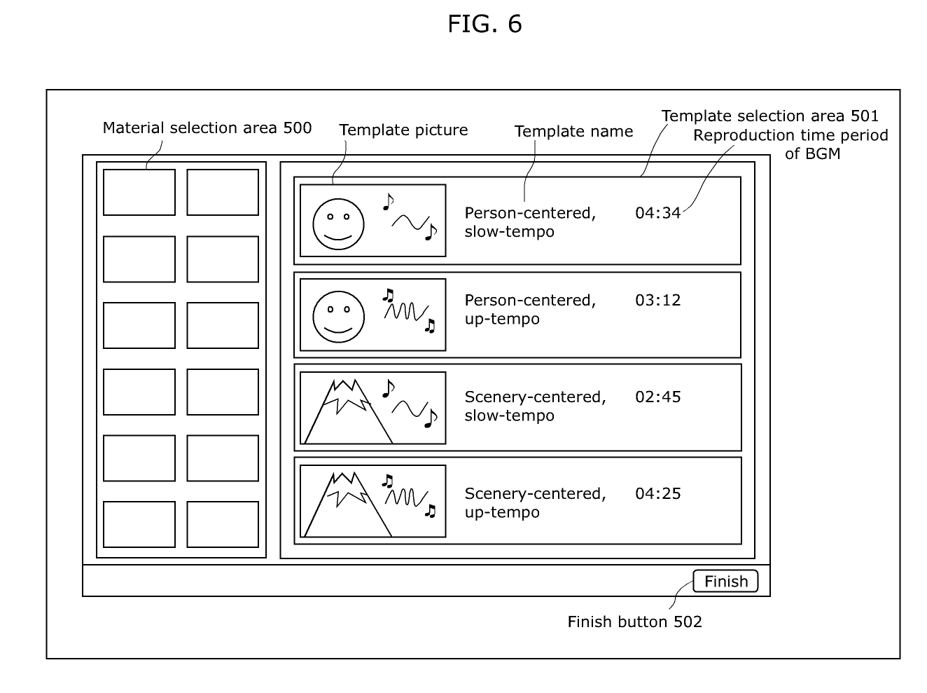

Subsequently, a structure of a selection screen that is an example of an operation screen for the picture editing apparatus 100, which is displayed on the liquid crystal display 109, is described with reference to FIG. 6. FIG. 6 shows an image of the selection screen on the liquid crystal display 109.

As shown in FIG. 6, the selection screen on the liquid crystal display 109 includes a material selection area 500, a template selection area 501, and a finish button 502.

The material selection area 500 is an area in which picture data items to be material for creating content data are displayed. The picture data items to be the material include still picture data and moving picture data. As shown in FIG. 6, a plurality of picture data items are displayed in the material selection area 500. The picture data items which are displayed in the material selection area 500 may be all the picture data items stored in the HDD 104. Alternatively, they may be only selectively extracted picture data items stored in a particular folder. Alternatively, they may be extracted picture data items which a user selected from among the picture data items stored in a particular folder.

It may also be possible that, for the picture data items displayed in the material selection area 500, a user can set priorities as picture data items that the user wishes to include into the content data. In this case, the picture data items displayed in the material selection area 500 become candidate pictures to be included into the content data when creating the content data, and in the case where it is not possible to adopt all the pictures, a picture data item with a high priority can be preferentially adopted. This makes it possible to create content data in which pictures desired by a user are adopted.

The template selection area 501 is an area in which templates selectable by a user are displayed. As the templates selectable by a user, “Person-centered, slow-tempo template”, “Person-centered, up-tempo template”, “Scenery-centered, slow-tempo template”, and “Scenery-centered, up-tempo template” are displayed, for example, as shown in FIG. 6. The “Person-centered, slow-tempo template” is a template which is suited to be used for a picture including an image of a person and describes a story configured using the presentation effect that fits slow-tempo background music (BGM). Likewise, the “Person-centered, up-tempo template” is a template which is suited to be used for a picture including an image of a person and describes a story configured using the presentation effect that fits up-tempo BGM. The “Scenery-centered, slow-tempo template” is a template which is suited to be used for a picture including an image of scenery and describes a story configured using the presentation effect that fits slow-tempo BGM. The “Scenery-centered, up-tempo template” is a template which is suited to be used for a picture including an image of scenery and describes a story configured using the presentation effect that fits up-tempo BGM. In each template display region, an image picture of the template, the template name, the reproduction time period of the BGM that is set for the template, and so on, are displayed. A user can select the template by operating the mouse 105. Thus, with the templates of plural types prepared, the atmosphere of the content data to be created can be changed.

The finish button 502 is a button for completing the selection of material pictures and template for content data creation. A user can complete the selection by pressing the finish button 502 with the use of the mouse 105. Completion of the selection for content data creation leads to creation of content data based on the picture data items selected as the material pictures in the material selection area 500 and the template selected in the template selection area 501.

### [6. Structure of Check Screen]

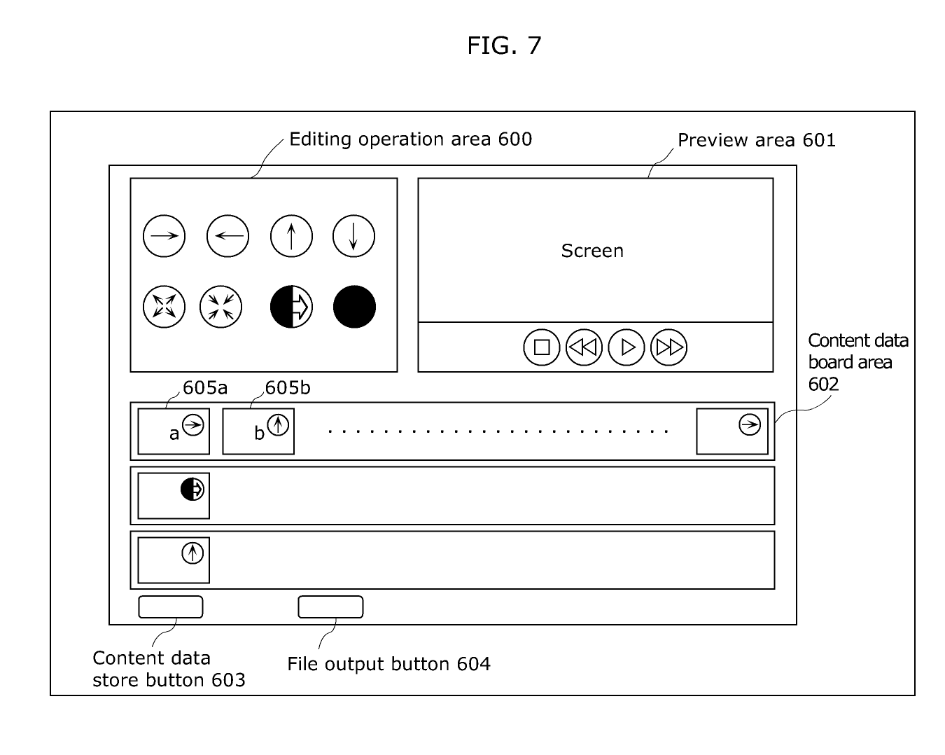

Subsequently, a structure of a check screen that is an example of an operation screen for the picture editing apparatus 100, which is displayed on the liquid crystal display 109, is described with reference to FIG. 7. FIG. 7 shows an image of the check screen on the liquid crystal display 109.

As shown in FIG. 7, the check screen on the liquid crystal display 109 includes an editing operation area 600, a preview area 601, a content data board area 602, a content data store button 603, and a file output button 604.

The preview area 601 is a screen for reproducing the created content data. A user is able to check actual details of the created content data on video.

The content data board area 602 is an area for displaying the details of the created content data. In the content data board area, a plurality of boxes (605a, 605b, . . . ) are arranged in an array. The order of the arranged boxes corresponds to the order of display on the content data. In each of the boxes, a picture extracted from the pictures displayed in the material selection area 500 is placed. Furthermore, in each of the boxes, an icon indicating the presentation effect of the picture is also displayed. In addition, although not shown, an icon indicating the transition effect between the pictures may be displayed in each of the boxes. In addition, although not shown, a reproduction time period for displaying a movie from the pictures placed in the boxes may also be displayed. Furthermore, the icon of the presentation effect and the icon of the transition effect may be displayed apart from the box. This allows a user to check which material is placed on the content data in what order, with which presentation effect, with which transition effect, and for what reproduction time period.

The editing operation area 600 is an area for editing the presentation effect for each of the boxes (605a, 605b, . . . ) in the content board area. A user can select, using the mouse 105, a desired presentation effect for each of the boxes.

The content data store button 603 can be selected with the use of the mouse 105. A user can store content data information into the HDD 104 by pressing the content data store button 603. The content data information includes information for managing which material is placed in what order, with which presentation effect, with which transition effect, and for what reproduction time period. It may be configured such that, although not shown, a content data readout button is provided in a screen of an upper hierarchy and the content data information stored as above can be read out.

The file output button 604 can be selected with the use of the mouse 105. By pressing the file output button 604, a user can create a video file based on the created content data information. An output format of the video file created as above may be selected by a user in advance. Specifically, in the case where a user selects the advanced video coding high definition (AVCHD) file format, a video file in AVCHD file format is created.

### [7. Structural Information of Template]

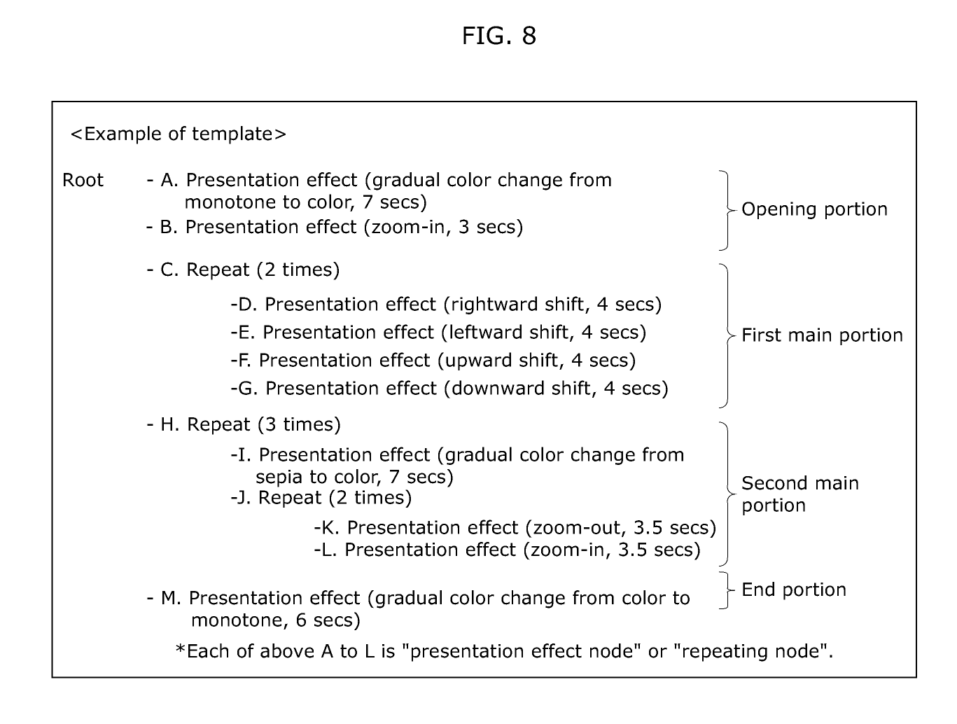

Subsequently, information of the template is described. FIG. 8 illustrates a hierarchical structure of the template according to this embodiment.

The template is information which states which presentation effects are sequentially arranged in what order in creating story data. In the template, how long reproduction time period is allocated for each of the presentation effects with the order is stated. The picture editing apparatus 100 arranges the presentation effects sequentially in the order of the presentation effects stated in the template.

With reference to FIG. 8, an example of the template is described. As shown in FIG. 8, the template has an opening portion, a first main portion, a second main portion, and an end portion. Although the case where there are two main portions: the first main portion and the second main portion is shown as an example in this embodiment, the template may have only one main portion or may have three or more main portions.

Each of the opening portion, the first main portion, the second main portion, and the end portion includes a presentation effect node or a repeating node having one or more presentation effect nodes. The presentation effect node has information on a reproduction time period of the material and information on a type of the presentation effect. It is to be noted that the presentation effect node is not able to have child nodes. According to the reproduction time period and the presentation effect designated in each of the presentation effect nodes, the picture editing apparatus 100 displays pictures. The repeating node has information for repeating, the designated number of repeating times, an effect node which belongs to a child node of the repeating node, or a repeating node which belongs to the child node. In the case of the repeating node, a series of nodes (child node 1, child node 2, . . . , and child node n) designated as child nodes can be sequentially repeated multiple times. In the case of one-time repetition, the display order will be (child node 1), (child node 2), . . . , and (child node n), and in the case of two-time repetitions, the display order will be (child node 1), (child node 2), . . . , (child node n), (child node 1), (child node 2), . . . , and (child node n).

As above, a story is created using the number of repeating times set by default, and with reference to FIG. 8, the order of the presentation effect nodes will be (A), (B), (D), (E), (F), (G), (D), (E), (F), (G), (I), (K), (L), (K), (L), (I), (K), (L), (K), (L), (I), (K), (L), (K), (L), and (M). As above, the template has a tree structure with the repeating node and the presentation effect node.

Although a type of the presentation effect and a reproduction time period thereof are stated in FIG. 8, it may also be possible that only the reproduction time period is stated. In this case, the picture editing apparatus 100 arranges the presentation effects with no presentation effects, sequentially in the order of the reproduction time periods stated in the template.

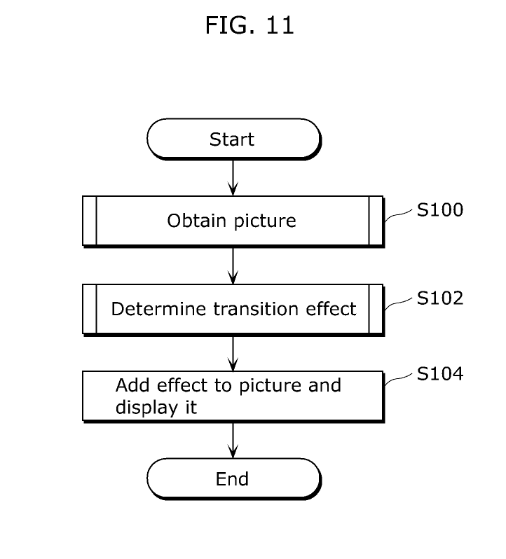

A flow of entire processing which the picture editing apparatus 100 performs as described above is described with reference to FIG. 11.

FIG. 11 is a flowchart showing the flow of entire processing which the picture editing apparatus 100 according to Embodiment performs.

First, the obtainment unit 150 obtains a plurality of pictures from the HDD 104, for example (S100).

Next, the transition effect determination unit 160 determines the transition effect that is the display processing to be performed on at least one of one picture and the following picture in switching between the one picture and the following picture, from among a plurality of candidate transition effects which are determined based on the presentation effect previously associated with the one picture as the display processing to be performed on each of the obtained pictures in sequentially displaying the pictures on the display apparatus 200 (S102).

At the end, the display control unit 170 adds the presentation effects and the transition effect to the plurality of pictures and causes the display apparatus 200 to sequentially display the resultant pictures (S104).

### [8. Story Creation Operation]

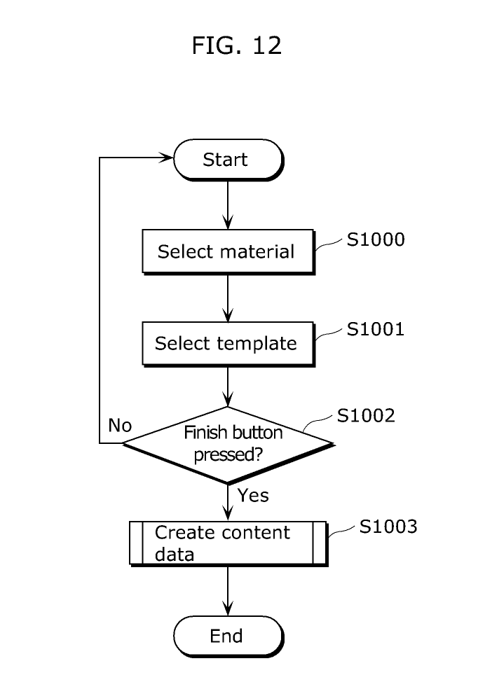

Subsequently, the procedure in which the picture editing apparatus 100 creates the content data based on the selected material and the selected template is described in detail. FIG. 12 is a flowchart showing a process flow in which the picture editing apparatus 100 according to Embodiment creates the content data. The flowchart shown in FIG. 12 describes details of Step S100 and Step S102 of FIG. 11.

First, a user selects a picture to be used to create content data (S1000). After the selection of the picture, the picture editing apparatus 100 displays the selected picture in the material selection area 500. Furthermore, as described above, a user may set the priorities here.

Subsequently, a user selects a template to be used to create content data (S1001). With the template selected, the picture editing apparatus 100 highlights that template in the template selection area. The operation in Step S1000 and the operation in Step S1001 may be performed in a switched order.

After finishing selection of the material and the template to be used to create the content data, a user can finalize the selected details by pressing the finish button 502 (S1002). The picture editing apparatus 100 then creates, according to the selected details, the content data describing which picture is to be used with which presentation effect, for how long, and with which transition effect between the picture and the following picture (S1003).

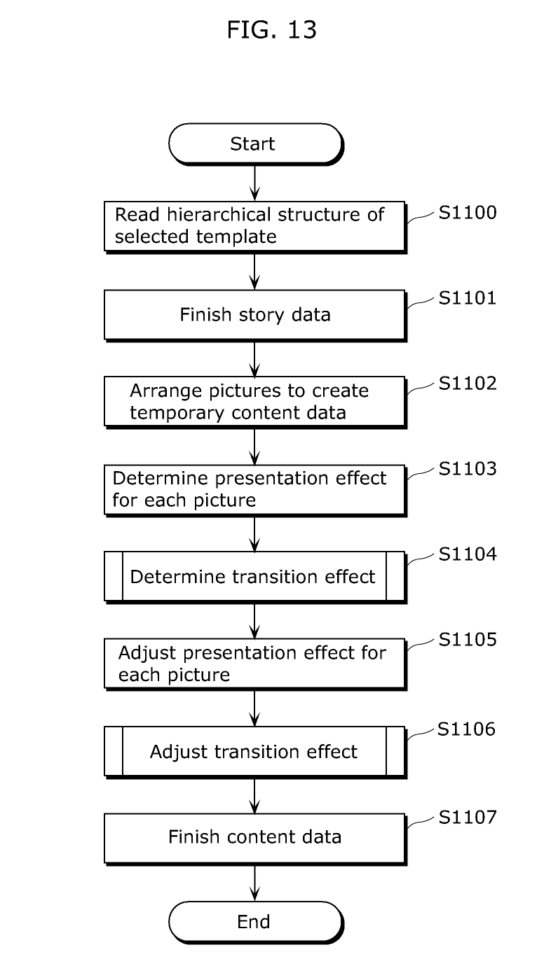

Subsequently, detailed operation of the content data creation in Step S1003 is described with reference to FIG. 13.

FIG. 13 is a detailed flowchart showing processing (Step S1003 of FIG. 12) in which the picture editing apparatus 100 according to Embodiment creates the content data.

First, the picture editing apparatus 100 reads out the information of the template selected in Step S1001 (S1100). Next, the picture editing apparatus 100 creates the story data according to the setting of the template (S1101). At this time, when the template includes the presentation effects, then the picture editing apparatus 100 sequentially arranges the presentation effects into the story data according to the template. On the other hand, when the template includes no presentation effects, then the picture editing apparatus 100 sequentially arranges “no presentation effects” into the story data. It is to be note that this arrangement of the presentation effects based on the template is provisional. As will be described, this arrangement is adjusted based on the shooting information of the arranged pictures, the preceding and following presentation effects, and so on, before the finalized presentation effect is determined.

Subsequently, the picture editing apparatus 100 creates temporary content data by arranging the pictures on the time axis indicated in the created story data (S1102). Specifically, the picture editing apparatus 100 sorts, by shooting date and time, the pictures displayed in the material selection area 500, and sequentially allocates them to the nodes in the story data. When the number of pictures to be material is smaller than the number of nodes in the story data, the same material picture is used multiple times at random. When the number of pictures to be material is larger than the number of nodes in the story data, the material to be used may be selected, for example, under the following condition.
Condition 1: pictures are selected uniformly from all the materials without any bias as to shooting date and time.
Condition 2: when a person-centered template is selected as the template, pictures in which a person is the main subject are preferentially selected.
Condition 3: when a scenery-centered template is selected as the template, pictures in which scenery is the main subject are preferentially selected.
Condition 4: when the pictures displayed in the material selection area 500 are set with priorities in step S1000, pictures having higher priority are preferentially selected.

Next, the presentation effect determination unit 155 determines the presentation effect of each picture (S1103).

Specifically, the presentation effect determination unit 155 determines the presentation effect with reference to the table indicating the association between the shooting information of the obtained picture and the presentation effect. With reference back to FIG. 4 as an example, when the shooting information added to the obtained picture is “Horizontal shot picture”, the corresponding presentation effect list includes four candidate presentation effects: “Parallel rightward shift”, “Parallel leftward shift”, “Zoom-in”, and “Zoom-out”. The presentation effect determination unit 155 selects, at random, one of these candidates as the presentation effect. Furthermore, when the shooting information is “Horizontal shot picture” and the picture is “Picture shot in portrait mode”, the presentation effect list having a higher priority, which corresponds to “Picture shot in portrait mode”, is used. Specifically, the presentation effect determination unit 155 selects, at random, one of the six candidate presentation effects: “Zoom-in with person centered”, “Zoom-out with person centered”, “Parallel rightward shift to include person”, “Parallel leftward shift to include person”, “Parallel upward shift to include person”, and “Parallel downward shift to include person” as the presentation effect.

In the case where the presentation effect temporarily determined in the story data in Step S1101 is included in the presentation effect list which corresponds to the shooting information of the picture and has the highest priority, the presentation effect determination unit 155 adopts, without any changes, the presentation effect temporarily determined in Step S1101.

Next, the transition effect determination unit 160 determines the transition effect between the pictures (S1104). Specifically, the transition effect determination unit 160 refers to the transition table indicating the association between the presentation effect and the transition effect. Next, the transition effect determination unit 160 determines the transition effect to be used, from among the candidate transition effects included in the transition effect list corresponding to the presentation effect.

More specifically, with reference back to FIG. 5, the transition effect determination unit 160 refers to the transition table indicating the association between the presentation effect and the transition effect. Here, assume that the transition effect determination unit 160 determines the transition effect to be used in switching from the first picture to the second picture. Furthermore, assume that the presentation effect before transition which is set for the first picture is “Parallel leftward shift” and that the presentation effect after transition which is set for the second picture is “Parallel rightward shift”. In this case, the transition effect list corresponding to the two presentation effects before and after transition includes three candidate transition effects: “Cross-fade”, “Slide-in left”, and “Slide-in right”. Accordingly, the transition effect determination unit 160 selects one of the three candidates at random.

As described above, in FIG. 5, there are two transition effect lists which correspond to the case where the presentation effect before transition is “Zoom-in” and the presentation effect after transition is “Zoom-in”. In such a case, the transition effect determination unit 160 selects the transition effect from the transition effect list with a high priority. In the case of FIG. 5, the transition effect determination unit 160 selects “Burst” wit a higher priority 3.

In the case where a picture with both of its sequential pictures having the presentation effect “Zoom-in” is repeated, constant adoption of the transition effect with a higher priority will result in repetition of the transition effect “Burst”. In order to avoid this, as will be described in Step S1106, the transition effect determination unit 160 may adopt, as the following transition effect, the transition effect “Spin-in” with the priority 2 when the transition effect with the priority 3 is sequentially repeated. Specifically, when the presentation effect “Zoom-in” is repeated, the transition effect determination unit 160 may select the transition effects “Burst” and “Spin-in” alternatively in a repetitive manner.

Subsequently, the presentation effect determination unit 155 may adjust the presentation effect of the created content data (S1105). The succession of the same presentation effect will lead to a redundant view. The presentation effect determination unit 155 therefore checks whether the same presentation effect continues or not, and changes the type of the presentation effect when the presentation effect is the same as the immediately preceding presentation effect.

Specifically, the presentation effect determination unit 155 determines, as the presentation effect, another one of the candidates, instead of the successive presentation effect of the same type, which are stated in the above-described table indicating the associated between the shooting information of the obtained picture and the presentation effect. When there is no other candidate, the presentation effect with a lower priority is determined. For example, assume that the presentation effect of a target picture is “Zoom-in” and the presentation effect of its immediately preceding picture is also “Zoom-in. In this case, the same presentation effect continues. The presentation effect determination unit 155 therefore changes, in Step S1105, the presentation effect to be used for the target picture. Here, when the shooting information of the picture is “Vertical shot picture”, the presentation effect determination unit 155 may select, as the corresponding presentation effect, one of the three presentation effects: “Parallel downward shift”, “Parallel upward shift”, and “Zoom-out”, other than “Zoom-in”. However, when the presentation effect list corresponding to “Vertical shot picture” includes “Zoom-in” only, another presentation effect needs to be found by lowering the priority. Here, since the priority of “Vertical shot picture” is “1”, the shooting information is searched for which corresponds to the picture and has a priority lower than “1”. The presentation effect list corresponding to a priority “0” corresponds to “Any picture” in the shooting information. Thus, it is sufficient that the presentation effect determination unit 155 selects the presentation effect other than “Zoom-in” from the presentation effect list corresponding to “Any picture”.

The redundancy of the presentation effect may be determined based on whether the presentation effect is the same as the immediately preceding presentation effect as described above, or may also be determined based on a numerical value; for example, four successive presentation effects of the same type are determined as redundant. Furthermore, even when the same presentation effect does not continue, the determination may be made based on whether the same presentation effect is included within a predetermined range; for example, the case where a picture located within three pictures before and after the target picture is provided with the same presentation effect.

Subsequently, the transition effect determination unit 160 may adjust the transition effect of the created content data (S1106). This is because the succession of the same presentation effect will lead to a redundant view. The transition effect determination unit 160 checks whether or not the same transition effect continues. Here, when the transition effect is the same as the immediately preceding transition effect, a type of the transition effect is changed.

Specifically, the transition effect determination unit 160 refers to the transition table. Subsequently, from among the candidate transition effects included in the transition effect list corresponding to the presentation effect, a transition effect different from the transition effect to be changed is selected. When there is no other candidate, the transition effect determination unit 160 selects the transition effect in the transition effect list with a lower priority. For example, when the transition effect designated for a certain picture is “Rotate” and the transition effect designated for the following picture is also “Rotate”, the same transition effect will continue. Thus, the transition effect determination unit 160 changes the transition effect designated for the following picture. For example, at this time, when the presentation effect designated for the certain picture is “Zoom-in” and the presentation effect designated for the following picture is “Zoom-out”, “Spin-in” may be selected.

When the transition effect list corresponding to the presentation effect includes no transition effects other than “Rotate”, the transition effect determination unit 160 selects a transition effect from the transition effect list with a lower priority. For example, the transition effect designated for a certain picture is “Burst” and the transition effect designated for the following picture is also “Burst”, the same transition effect continues. Thus, the transition effect determination unit 160 changes the transition effect designated for the following picture. Here, when the presentation effect designated for a certain picture is “Zoom-in” and the presentation effect designated for the following picture is “Zoom-in”, the corresponding transition effect list includes no candidate transition effects other than “Burst”. Thus, the transition effect determination unit 160 searches for other transition effect in the transition effect list with a lower priority. At this time, since the priority of the corresponding transition effect list is “3”, the transition effect determination unit 160 searches for the transition effect list which corresponds to the presentation effect and has a priority lower than “3”. Then, the transition effect list is found which corresponds to “Zoom-in” in the presentation effect before transition and “Zoom-in” in the presentation effect after transition and has a priority “2”. Thus, the transition effect determination unit 160 selects a presentation effect included in this transition effect list. For example, “Spin-in” is selected as a result of random selection.

A criterion for the transition effect determination unit 160 to determine that the transition effect is redundant may be whether or not the transition effect is the same as the immediately preceding transition effect as described above. Alternatively, a numerical value may be used for the determination; for example, that is the case where there are four successive transition effects of the same type. Furthermore, even when the same transition effect does not continue, the determination may be made based on whether the same transition effect is included within a predetermined range; for example, the case where a picture located within three pictures before and after the target picture is provided with the same transition effect.

With the above operation, the picture editing apparatus 100 completes the content data (S1107). The operation of content data creation then ends.

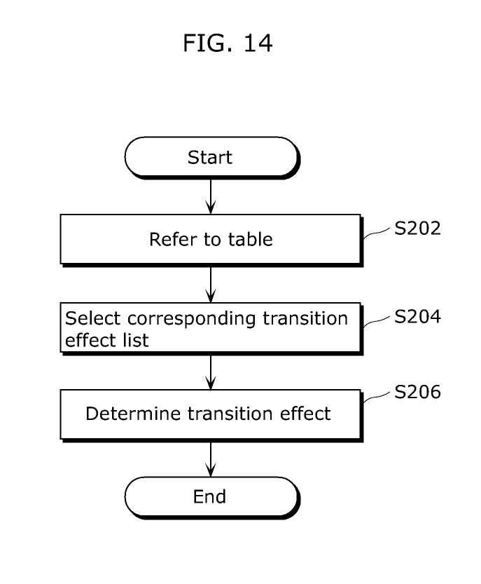

FIG. 14 is a flowchart showing a detailed flow of processing which the transition effect determination unit 160 performs in the above Step S1104.

First, the transition effect determination unit 160 refers to the transition table (S202). In the transition table, a set of the presentation effect associated with the first picture included in a plurality of pictures and the presentation effect associated with the second picture that is at least one of the pictures which are displayed immediately preceding and following the first picture is associated with the transition effect list that indicates a plurality of candidate transition effects to be used in switching from the first picture to the second picture (S202).

Next, the transition effect determination unit 160 selects a transition effect list which corresponds to a set of the presentation effects designated for sequential pictures on which the transition effect is to be determined (S204). The transition effect list may have a priority. In this case, when there is a plurality of corresponding transition effect lists, the transition effect determination unit 160 selects a transition effect list with a higher priority.

At the end, the transition effect determination unit 160 determines the transition effect from among the candidate transition effects included in the transition effect list (S206). The transition effect determination unit 160 may determine the transition effect at random. Alternatively, the transition effects may be sequentially selected in order of arrangement thereof in the transition effect list and thus determined.

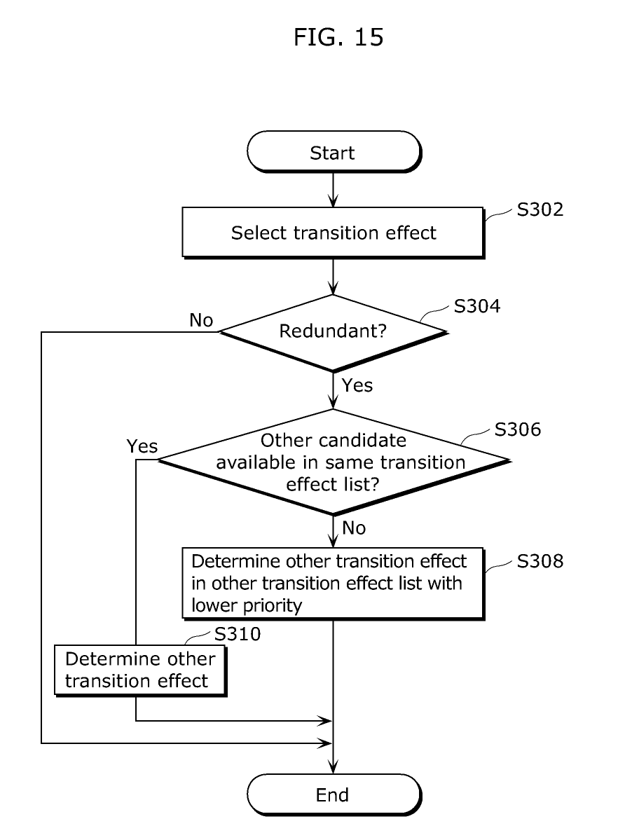

FIG. 15 is a flowchart showing a detailed flow of processing which the transition effect determination unit 160 performs in the above Step S1106.

First, the transition effect determination unit 160 selects, as a target on which redundancy is determined, the transition effect determined in the processing shown in FIG. 14, for example (S302).

Next, the transition effect determination unit 160 determines whether or not the selected transition effect is redundant (S304). The criterion for the redundancy is as described above. Here, when it is determined that the transition effect is not redundant (No in S304), the transition effect determination unit 160 determines, as the transition effect to be adopted ultimately, the transition effect selected in Step S302. On the other hand, when it is determined that the transition effect is redundant (Yes in S304), the transition effect determination unit 160 determines whether or not the transition effect list including the transition effect determined as redundant includes other candidate transition effect (S306).

Here, when other candidate transition effect is included (Yes in S306), one of these candidates is determined as the transition effect to be adopted ultimately (S310). On the other hand, when no other candidate transition effect is included (No in S306), the transition effect determination unit 160 refers to the transition table again. Subsequently, another transition effect list is selected from among the transition effect lists which correspond to a set of the presentation effects determined for the respective target pictures. After that, the transition effect determination unit 160 determines, as the transition effect to be adopted ultimately, one of the candidate transition effects included in the newly selected transition effect list (S308).

### [9. Other Embodiment]

The present invention is not limited to the above embodiment, and other embodiments are conceivable. The following collectively describes other embodiments.

The above embodiment describes the processing until the picture editing apparatus 100 ends the operation of content data creation. In addition, a user may manually change the presentation effect after the above-described processing. After that, the picture editing apparatus 100 may further change the transition effects before and after the presentation effect manually changed by a user, so as to add transition effects suited to the presentation effect manually changed by a user. Specifically, when a preview screen shown in FIG. 7 is displayed on the liquid crystal display 109, a user can change, with use of the mouse 105, the presentation effect of a picture which the user wishes to change. With the change of the presentation effect of a certain picture by a user, the picture editing apparatus 100 may change, according to the table shown in FIG. 5, the transition effects to be used in switching between the picture of which presentation effect has been changed and pictures preceding and following the picture.

Furthermore, in the above embodiment, the transition effect determination unit 160 determines the transition effect (Step S1104 and Step S1106) every time the presentation effect is determined (Step S1103 and Step S1105). Alternatively, the transition effect determination unit 160 may determine the transition effect after completing the determination of all the presentation effects.

In the case of using, as the material picture, a plurality of pictures taken in continuous shooting mode, the presentation effect determination unit 155 may determine the presentation effect in association with the shooting information indicating the continuous shooting. For example, in this case, the presentation effect determination unit 155 may deal with a group of pictures which is composed of a plurality of continuously taken pictures, as a single picture group. The presentation effect determination unit 155 may determine the continuous use of the same transition effect for the pictures in the same picture group.

In the above embodiment, BGM is already determined. Alternatively, the picture editing apparatus 100 may set BGM which is optionally selected by a user. In this case, the picture editing apparatus 100 adjusts the length of the story data in Step S1103 so that the length of the story data fits the length of the BGM. For example, the picture editing apparatus 100 may temporally equally repeat or reduce the nodes described in the template.

Furthermore, in the above embodiment, the picture editing apparatus 100 sorts, by shooting data and time, the pictures displayed in the material selection area 500 in Step S1102. Alternatively, the picture editing apparatus 100 may sort the pictures at random. The type of sorting may be set by a user in advance.

Furthermore, the above embodiment describes the case where a personal computer (PC) 100 is used as the picture editing apparatus. However, the present invention is not limited to the above case. For example, in consideration of cloud services, an idea of the present invention may be implemented on the network. At this time, a user provides a picture for movie creation to a control device on the cloud services. The control device on the cloud services receives the picture for movie creation and then, according to the flowchart shown in FIG. 13, may create a movie and provide the movie to a local terminal of a user. In other words, the present invention is applicable to a system which uses a picture editing method including: obtaining a plurality of pictures for movie creation; determining a transition effect for displaying or hiding a picture to be displayed, based on a presentation effect associated with a target picture for movie creation; creating a movie based on the determined presentation effect and transition effect; and providing the movie.

While the movie is a short movie in the above embodiment, the present invention is applicable to slideshows.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to picture editing apparatuses. Particularly, the present invention is applicable to a picture editing apparatus capable of performing editing operation on a plurality of pictures which are displayed sequentially.

What is claimed is:

1. A picture editing apparatus which adds, to at least one of sequential pictures to be switched, a transition effect that is display processing to be performed in sequentially switching a plurality of pictures, said picture editing apparatus comprising:
an obtainment unit configured to obtain the pictures;
a transition effect determination unit configured to determine the transition effect to be added to the at least one of the sequential pictures to be switched, based on a presentation effect associated with the at least one of the sequential pictures to be switched, the presentation effect being associated with each of the obtained pictures as display processing to be performed in displaying the picture; and
a display control unit configured to add the presentation effect and the transition effect to the pictures and sequentially display the pictures on a display apparatus.

2. The picture editing apparatus according to claim 1,
wherein said transition effect determination unit is configured to determine the transition effect to be added in switching from one to the other of a first picture and a second picture, from among a plurality of candidate transition effects which are determined based on at least one of the presentation effect associated with the first picture and the presentation effect associated with the second picture, the first and the second pictures being included in the pictures, and the second picture being a picture which is displayed preceding or following the first picture.

3. The picture editing apparatus according to claim 2,
wherein the first picture is a picture which is displayed preceding the second picture, and
said transition effect determination unit is configured to determine, with reference to a transition table, the transition effect to be added, from among the candidate transition effects so that use frequency of each of the candidate transition effects is equal to or lower than a predetermined threshold, the transition table being a table in which at least one of a first presentation effect associated with the first picture and a second presentation effect associated with the second picture is associated with a plurality of candidate transition effects that can be added in switching from the first picture to the second picture.

4. The picture editing apparatus according to claim 3,
wherein each of the candidate transition effects has a priority, and
said transition effect determination unit is configured to determine to preferentially add the candidate transition effect with a higher priority.

5. The picture editing apparatus according to claim 3,
wherein said transition effect determination unit is configured to determine a transition direction of each of the first picture and the second picture in the transition effect so as to match at least one of a shift direction of the first picture in the first presentation effect and a shift direction of the second picture in the second presentation effect.

6. The picture editing apparatus according to claim 1, further comprising
a presentation effect determination unit configured to determine, from among a plurality of candidate presentation effects previously associated with shooting information added to each of the obtained pictures, the presentation effect to be associated with the picture, based on a priority of each of the candidate presentation effects.

7. A picture editing method of adding, to at least one of sequential pictures to be switched, a transition effect that is display processing to be performed in sequentially switching a plurality of pictures, said picture editing method comprising:
obtaining the pictures;
determining the transition effect to be added to the at least one of the sequential pictures to be switched, based on a presentation effect associated with the at least one of the sequential pictures to be switched, the presentation effect being associated with each of the obtained pictures as display processing to be performed in displaying the picture; and
adding the presentation effect and the transition effect to the pictures and sequentially displaying the pictures on a display apparatus.

8. A non-transitory computer-readable recording medium storing a program for causing a computer to execute said picture editing method according to claim 7.
